(19) United States
(12) Patent Application Publication
(10) Pub. No.: US 2018/0023270 A1
(43) Pub. Date: Jan. 25, 2018

(54) METHOD FOR CONTROLLING FLOW RATE OF HYDRAULIC PUMP OF CONSTRUCTION MACHINE

(71) Applicant: VOLVO CONSTRUCTION EQUIPMENT AB, Eskilstuna (SE)

(72) Inventor: Dong-Soo KIM, Gyeongsangnam-do (KR)

(73) Assignee: VOLVO CONSTRUCTION EQUIPMENT AB, Eskilstuna (SE)

(21) Appl. No.: 15/542,013

(22) PCT Filed: Jan. 8, 2015
(86) PCT No.: PCT/KR2015/000179

§ 371 Date: Jul. 6, 2017

(51) Int. Cl. E02F 9/12; F15B 13/044; E02F 9/22

(52) U.S. Cl. CPC E02F 9/123; E02F 9/2232; F15B 13/044

(57) ABSTRACT

A method is provided for controlling the flow rate of a hydraulic pump of a construction machine, including: a step of detecting the operation amount of a rotation operation lever, and the rotation pressure generated in a swing motor; a step of calculating the flow rate required for rotating, the flow rate corresponding to the operation amount of the rotation operation lever; a step of calculating a rotation acceleration first inclination value for increasing the discharge flow rate of the hydraulic pump to a certain inclination value from a rotation initiation time when the upper rotating body rotates; a step of calculating a second inclination value compensating for the first inclination value by a difference value between the detected rotation pressure value of the swing motor and the reference pressure corresponding to the set pressure of the relief valve of the swing motor; and to step of restricting the discharge flow rate of the hydraulic pump such that the increased amount of the flow rate required for rotating is restricted to the flow rate of the second inclination value.

### BACKGROUND AND SUMMARY

The present invention relates to a method for controlling flow rate of hydraulic pump, and more particularly, a method for controlling a discharge flow rate of hydraulic pump for construction machine in which the discharge flow rate can be restricted when an upper swing structure is suddenly revolved.

FIG. 1 is a hydraulic circuit of a swing control apparatus for construction machine according to the conventional technology.

As shown in FIG. 1, a variable displacement hydraulic pump (hereinafter, hydraulic pump (2) and a pilot pump (3) are connected to an engine (1).

A swing motor (4) that revolves an upper swing structure (not shown in figure) is connected to the hydraulic pump (2) which is driven by working oil.

A main control valve (MCV) (5) is installed in the flow path between the hydraulic pump (2) and the swing motor (4), which controls the working oil that is supplied from the hydraulic pump (2) to the swing motor (4).

A relief valve (6) that controls the brake torque of the swing motor (4) is installed in the swing motor (4). A swing operation lever (RCV) (7) is connected to the main control valve (5) and a controller (8), respectively, and applies a pilot pressure to shift the main control valve (5).

According to the aforementioned configuration, as the pilot pressure which is given by the working oil supplied from the pilot pump (3) corresponding to the operation amount of the swing operation lever (7) is applied to the main control valve (5), the working oil discharged from the hydraulic pump (2) is supplied to the swing motor (4) and thus the upper swing structure can be rotated or swiveled.

At the moment when the upper swing structure is rotated by operation of the swing operation lever (7), the working oil is unnecessarily or excessively supplied to the swing motor (4) from swing start to swing acceleration, which leads to the maximum discharge flow rate of the hydraulic pump (2), and thus not only causes the loss of hydraulic energy, but increases the fuel consumption.

Also, if the upper swing structure is suddenly revolved or swiveled by operation of the swing operation lever (7), the flow rate supplied from the hydraulic pump (2) to the swing motor (4) is abruptly increased to accelerate the swing motor (4). At this moment, the swing motor (4) maintains a preset relief pressure of the relief valve (6).

If the hydraulic pressure through the relief valve (6) exceeds a preset relief pressure due to the increased flow rate for the sudden rotation or swivel movement of the upper swing structure, the excessive working oil that is left over the amount required for driving the swing motor (4) is returned to the working oil tank through the relief valve (6).

Therefore, as the hydraulic energy is lost with the returned flow rate, it causes the problem of lowering the fuel efficiency.

Accordingly, it is desirable to provide a method for controlling a discharge flow rate of hydraulic pump for construction machine in which the excessive working oil returned through a relief valve can be minimized by reducing the discharge flow rate of the hydraulic pump when an upper swing structure is suddenly revolved or swiveled.

In accordance with an embodiment of the present invention, there is provided a method for controlling discharge flow rate of hydraulic pump for construction machine, including a variable displacement hydraulic pump; a swing motor that is driven by working oil of the hydraulic pump to revolving an upper swing structure; a swing operation lever; a detection means for detecting an operation amount of the swing operation lever; an electric proportional valve for controlling the working oil supplied to the swing motor from the hydraulic pump; a pressure sensor for detecting a swing pressure generated in the swing motor; and a controller to which the detected signals are inputted from the detection means and the pressure sensor, the method comprising;

a step of detecting the operation amount of the swing operation lever and the swing pressure generated in the swing motor;

a step of calculating the a flow rate required for the rotation corresponding swing motor response to the operation amount of the swing operation lever;

a step of calculating the first slope a first gradient value of the swing acceleration to increase the a discharge flow rate of of the hydraulic pump from the swing start, when the upper swing structure is to be rotated revolved;

a step of correcting the first slope gradient value to the a second slope gradient value by taking into account the a difference between the swing pressure detected in the swing motor and the reference pressure of the a preset relief valve pressure of a relief valve as a reference pressure; and

a step of reducing controlling the discharge flow rate of the hydraulic pump so that increasement of the required flow rate required for the rotation is reduced restricted to the a flow rate of corresponding to the second slope gradient value.

The method further comprises a step of controlling the discharge flow rate of the hydraulic pump if the flow rate corrected by the second gradent value is greater than the required flow rate corresponding to the operation amount of the swing operation lever, while controlling the discharge flow rate of the hydraulic pump in respponse to the corrected flow rate if the flow rate corrected by the second gradient value is smaller than the required flow rate corresponding to the operation amount of the swing operation lever.

The method comprises wherein the step of correcting the first gradient value to the second gradien value is carried out by compensaing the first gradient value to increase if the preset relief pressure is greater than the detected swing pressure, while compensating the first gradint value to decrease if the preset relief pressure is smaller than the detected swing pressure.

According to an embodiment of the present invention having the above-described configuration, when an upper swing structure of the excavator is suddenly revolved or swiveled against a lower traveling structure, the working oil to be necessary for revolving or swiveling the upper swing structure can be discharged from the hydraulic pump, and thereby the hydraulic energy loss can be minimized with fuel efficiency improved.

### BRIEF DESCRIPTION OF THE DRAWINGS

The above features and advantages of the present invention will become more apparent by describing the preferred embodiments thereof with reference to the accompanying drawings, in which:

FIG. 1 is a hydraulic circuit of a swing control apparatus for construction machine according to the conventional technology.

FIG. 2 is a hydraulic circuit of a swing control apparatus demonstrated for a method for controlling a discharge flow rate of hydraulic pump for construction machine according to an embodiment of the present invention.

FIG. 3 is a block diagram of a method for controlling a discharge flow rate of hydraulic pump for construction machine according to an embodiment of the present invention.

FIG. 4 is a flow chart of a method for controlling a discharge flow rate of hydraulic pump for construction machine according to an embodiment of the present invention.

FIG. 5 is a graph showing characteristic gradients for compensating a discharge flow rate so that the discharge flow rate does not exceed a required flow rate corresponding to an operation amount of the swing operation lever as well as a preset relief pressure of a relief valve according to a method for controlling a discharge flow rate of hydraulic pump for construction machine according to an embodiment of the present invention.

FIG. 6 is a graph showing gradient correction of a discharge flow rate in swing operation according to a method for controlling a discharge flow rate of hydraulic pump for construction machine according to an embodiment of the present invention.

### EXPLANATION OF REFERENCE NUMERALS FOR MAIN PARTS IN THE DRAWING

10; hydraulic pump
11; swing motor
12; swing operation lever
13; swing operation amount detection means
14, 15, 16, 17; electric proportional valve
18, 19; pressure sensor
20; controller
21; relief valve

### DETAILED DESCRIPTION

Hereinafter, a method for controlling a discharge flow rate of hydraulic pump for construction machine according to a preferred embodiment of the present invention will be described in detail with reference to the accompanying drawings.

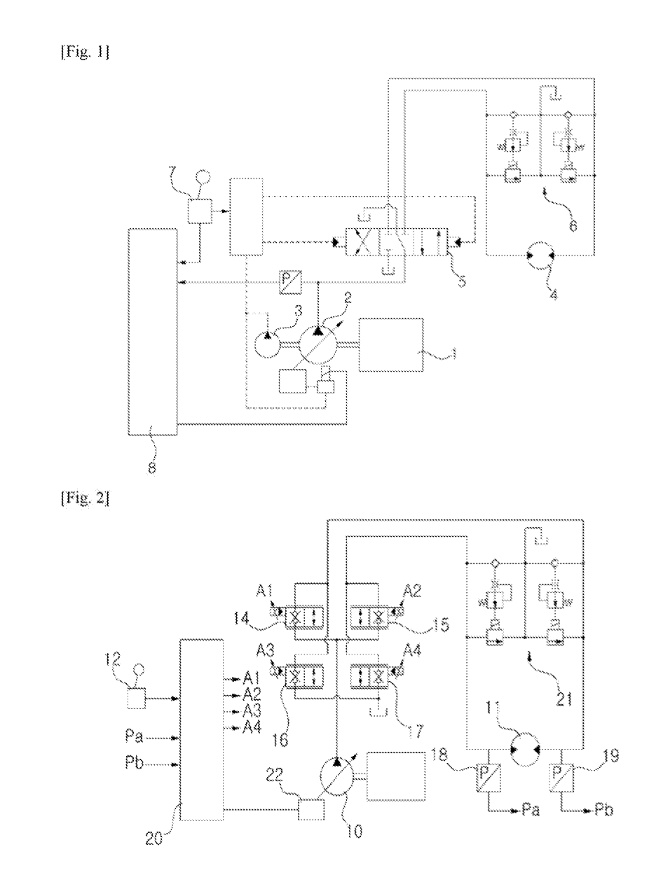

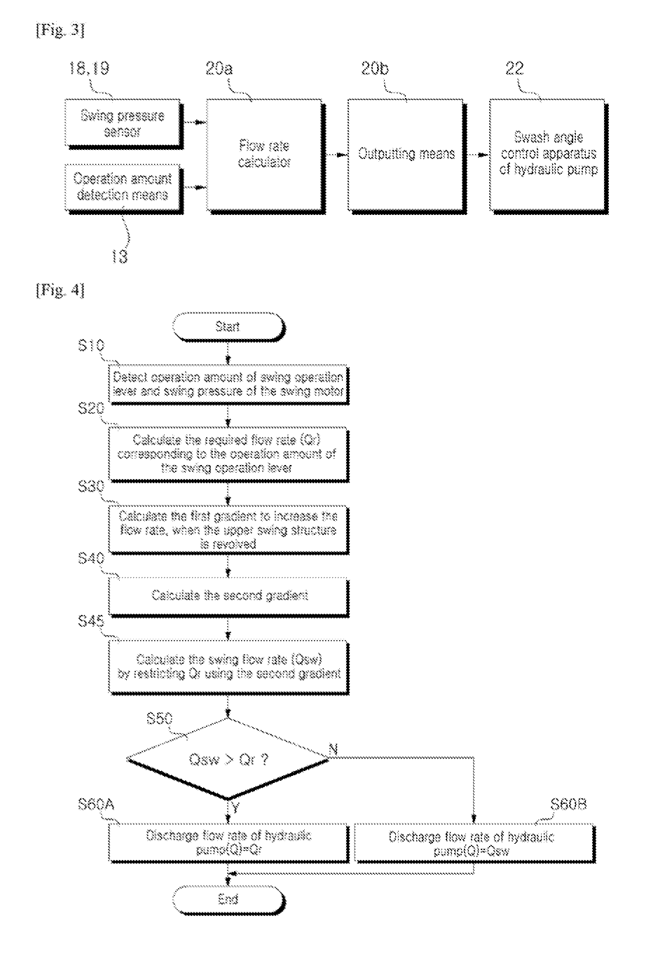

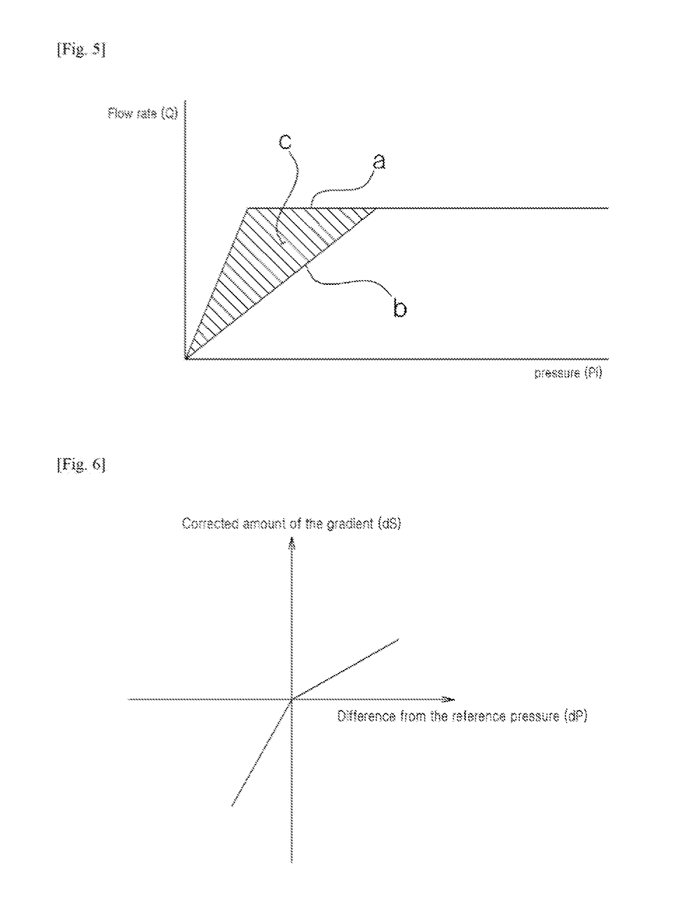

FIG. 2 is a hydraulic circuit of a swing control apparatus demonstrated for a method for controlling a discharge flow rate of hydraulic pump for construction machine according to an embodiment of the present invention. FIG. 3 is a block diagram of a method for controlling a discharge flow rate of hydraulic pump for construction machine according to an embodiment of the present invention. FIG. 4 is a flow chart of a method for controlling a discharge flow rate of hydraulic pump for construction machine according to an embodiment of the present invention. FIG. 5 is a graph showing characteristic gradients for compensating a discharge flow rate so that the discharge flow rate does not exceed a required flow rated corresponding to an operation amount of a swing operation lever as well as a preset relief pressure of the relief valve according to a method for controlling a discharge flow rate of hydraulic pump for construction machine according to an embodiment of the present invention. FIG. 6 is a graph showing gradient correction of a discharge flow rate in swing operation according to a method for controlling a discharge flow rate of hydraulic pump for construction machine according to an embodiment of the present invention.

Referring to FIGS. 2 to 6, according to an embodiment of the present invention, a method for controlling discharge flow rate of hydraulic pump for construction machine, including a variable displacement hydraulic pump (10); a swing motor (11) that is driven by working oil of a hydraulic pump (10) to revolving an upper swing structure (not shown); a swing operation lever (RCV) including an electric swing operation lever (12); a detection means (13) for detecting an operation amount of the swing operation lever (12); an electric proportional valve (14, 15, 16, 17) for controlling the working oil supplied to the swing motor (11) from the hydraulic pump (10); a pressure sensor (18, 19) for detecting a swing pressure generated in the swing motor (11); and a controller (20) to which the detected signals are inputted from the detection means (13) and the pressure sensor (18, 19), the method comprises;

a step (S10) of detecting the operation amount of the swing operation lever (12) and the swing pressure (Pa or Pb) generated in the swing motor (11);

a step (S20) of calculating a flow rate required for the swing motor (11) in response to the operation amount of the swing operation lever (12);

a step (S30) of calculating a first gradient (e,g. a slope a in FIG. 5) value of swing acceleration to increase a discharge flow rate of the hydraulic pump (10) from swing start as a slope value, when the upper swing structure is to be revolved;

a step (S40) of correcting the first gradient value to a second gradient value (e.g. a slope value compensated or corrected by a difference between a preset relief pressure as a reference pressure and the detected pressure in FIG. 6) by taking into account a difference between the swing pressure (Pa or Pb) detected in the swing motor (11) and a reference pressure of a preset relief valve (21) pressure of the swing motor (11); and

a step (S50) of controlling the discharge flow rate of the hydraulic pump (10) so that the required flow rate required for revolving the swing motor is restricted to the discharge flow rate of the second gradient.

The method further comprises the step (S60) of discharging the discharge flow rate from the hydraulic pump (10) in response to the swing operation lever if the flow rate corrected by the second gradient is greater than the required flow rate corresponding to the operation amount of the swing operation lever (12), and while controlling the discharge flow of the hydraulic pump (10) in response to the corrected flow rate from the hydraulic pump (10) if the flow rate corrected by the second gradient is smaller than the required flow rate corresponding to the operation amount of the swing operation lever (12).

The step of correcting the first gradient value to the second gradient value is carried out by correcting or compensating the first gradient value to increase if the reference pressure of the preset relief pressure for the relief valve (21) is greater than the swing pressure detected in the swing motor (11), and while correcting or compensating the first gradient to decrease if the reference pressure of the preset relief pressure is smaller than the swing pressure detected in the swing motor (11).

According to the configuration above, as shown in S10, when the upper swing structure is rovolved by operation of the swing operation lever (12), the operation amount of the swing operation lever (12) is detected by the operation amount detection means (13), and the detected signal is inputted to the controller (20).

Also, when the swing motor (11) is driven by the working oil supplied from the hydraulic pump (10) as the electric proportional valve (14, 15, 16, 17) is shifted by the swing operation lever (12), the swing pressure (Pa, Pb) generated in the flow path of the swing motor (11) is detected by the pressure sensor (18, 19) and inputted to the controller (20).

Here, since the configuration of driving the swing motor by the working oil supplied from the hydraulic pump (10) as the electric proportional valve (14, 15, 16, 17) is shifted by the controller (20) in response to operation of the swing operation lever (12) is used in the field of the present invention, the detailed explanation regarding such configuration will be omitted.

As shown in S20, as the detected signal according to the operation amount of the swing operation lever (12) is outputted to the controller (20), the required flow rate (Qr) corresponding to the operation amount of the swing operation lever (12) is calculated in the flow rate calculation part (20a) of the controller (20).

As in S30, the first gradient value of the swing acceleration is calculated to increase the discharge flow rate of the hydraulic vamp (10) from swing start, when the upper swing structure is to be revolved by driving the swing motor (11). That is, the first gradient is Sref, and the arbitrary reference value of the gradient as a slope can be set experimentally although the optimal slope or gradient varies according to a position or an inertia of the upper working device.

As in S40, the second slope value is calculated by taking into account the difference between the swing pressure (Pa or Pb) detected in the swing motor (11) and the reference pressure of the preset relief pressure of the relief valve (21) associated with the swing motor (11). At this point, the corrected difference of the first gradient is given as follows, dS=dS(dp) (FIG. 6), dp=Prelief (the preset relief valve pressure of the swing Motor (11))—Psw (the detected pressures Pa, Pb of the swing motor). The corrected second gradient (5) is , S=Sref+dS.

As in S45, a swing flow rate (Qsw) is calculated or compensated by restricting a required flow rate (Qr) corresponding to the value of the second gradient. One of the ways to restrict the flow rate is as follows. Qsw(t)=Qsw(t-1)+S×dT. Here, Qsw(t-1) is the previously calculated Qsw, and dT is the sampling time.

As in S50, in order to reduce the flow rate to the value of the second slope, the calculated swing flow rate (Qsw) is compared with the required flow rate (Qr) corresponding to the operation amount of the swing operation lever (12). If Qsw is greater than Qr, it proceeds to S60A, and if Qsw is smaller than Qr, it proceeds to S60B.

As in S60A, if Qsw is greater than Qr, the electrical signal is applied through an output means (20b) of the controller (20) to an regulator (22) for adjusting the swash angle of the hydraulic pump (10), so that Qr is discharged from the hydraulic pump (10).

As in 60B, if Qsw is smaller than Qr, an electrical signal is applied through the output means (20b) of the controller (20) to the regulator (22) for adjusting the swash angle of the hydraulic pump (10), so that Qsw is discharged from the hydraulic pump (10).

As described above, according to the method for controlling the flow rate of the hydraulic pump of the construction machine according to an embodiment of the present invention, even when the upper swing structure is suddenly revoled, the discharge flow rate is optimally restricted or reduced so that only the discharge flow rate required for a torque where the upper swing structure is in swing start is controlled for the swing motor (11), and thus the working oil that returns to the oil tank through the relief valve (21) of the swing motor (11) can be reduced.

Although the present invention has been described with reference to the preferred embodiment in the attached figures, it is to be understood that various equivalent modifications and variations of the embodiments can be made by a person having an ordinary skill in the art without departing from the spirit and scope of the present invention as recited in the claims.

### INDUSTRIAL APPLICABILITY

According to the present invention having the above-described configuration, as the flow rate is discharged in the reduced amount only necessary for the rotation when the upper structure of the excavator is suddenly rorevolved, the loss in flow rate that returns through the relief valve can be minimized while securing the swing acceleration of the upper swing structure.

1. A method for controlling discharge flow rate of hydraulic pump for construction machine, including a variable displacement hydraulic pump; a swing motor that is driven by working oil of the hydraulic pump to revolving an upper swing structure; a swing operation lever; a detection means for detecting an operation amount of the swing operation lever; an electric proportional valve for controlling the working oil supplied to the swing motor from the hydraulic pump; a pressure sensor for detecting a swing pressure generated in the swing motor; and a controller to which the detected signals are inputted from the detection means and the pressure sensor, the method comprising;
detecting the operation amount of the swing operation lever and the swing pressure generated in the swing motor;
calculating a flow rate required for the swing motor in response to the operation amount of the swing operation lever;
calculating a first gradient value of swing acceleration to increase a discharge flow rate of the hydraulic pump from swing start, when the upper swing structure is to be revolved;
correcting the first gradient value to a second gradient value by taking into account a difference between the swing pressure and a preset relief pressure of a relief valve as a reference pressure; and
controlling the discharge flow rate of the hydraulic pump so that increase of the required flow rate is restricted to a flow rate corresponding to the second gradient value.

2. The method of claim 1, further comprising a step of controlling the discharge flow rate of the hydraulic pump if the flow rate corrected by the second gradient value is greater than the required flow rate corresponding to the operation amount of the swing operation lever, while controlling the discharge flow rate of the hydraulic pump in response to the corrected flow rate if the flow rate corrected by the second gradient value is smaller than the required flow rate corresponding to the operation amount of the swing operation lever.

3. The method of claim 1, wherein the step of correcting the first gradient value to the second gradient value is carried out by compensating the first gradient value to it if the preset relief pressure is greater than the detected swing pressure, while compensating the first gradient value to decrease if the preset relief pressure is smaller than the detected swing pressure.
